(19) United States
(12) Patent Application Publication
(10) Pub. No.: US 2022/0180137 A1
(43) Pub. Date: Jun. 9, 2022

(54) WORKPIECE MARKING

(71) Applicant: HOMAG GmbH, Schopfloch (DE)

(72) Inventor: Markus KOSTENBADER, Bondorf (DE)

(21) Appl. No.: 17/440,726

(22) PCT Filed: Mar. 17, 2020
(86) PCT No.: PCT/EP2020/057219

§ 371 Date: Sep. 17, 2021

(30) Foreign Application Priority Data
Mar. 18, 2019 (DE) 10 2019 106 799.5

(51) Int. Cl. G06K 19/06; B44C 5/04

(52) U.S. Cl. CPC G06K 19/06037; B44F 9/02; G06K 19/06028; B44C 5/04

(57) ABSTRACT

The invention relates to a workpiece with a manufactured surface structure that forms a decorative pattern, wherein an optically detectable coding is integrated in a reference area of the surface structure of the workpiece. The invention further provides a method for manufacturing a workpiece with such a coding or marking. Such a workpiece can, for example, be a workpiece or an object used in the field of furniture or components industry, in particular a piece of furniture or a part of a piece of furniture.

### TECHNICAL FIELD

The invention relates to a workpiece that is in particular manufactured by an additive process and is provided with a coding or marking. The invention further provides a method for manufacturing a workpiece having such coding or marking. Such a workpiece can, for example, be a workpiece or an object used in the field of furniture or components industry, in particular a piece of furniture or a part of a piece of furniture.

### PRIOR ART

In the prior art, different methods are known with which workpieces can be additively manufactured. Due to a significant increase in the performance of corresponding machines, additive processes are now relevant not only for the construction of prototypes, but also in the field of mass production of components.

Further known are manufacturing processes by means of which workpieces are provided with an individual decorative pattern to increase the value of these workpieces. For example, workpieces are printed to imitate a specific wood surface structure.

The individualized single piece production on an industrial scale leads to the requirement for workpieces to be marked during the manufacturing process or even beyond in order to clearly mark the corresponding workpiece. However, not all workpieces that are additively manufactured or printed with a surface structure in the course of manufacture can be provided with conventional barcode labels, for example since the surface of the workpiece does not permit this or a longer curing time must be observed. The marking of these workpieces and the otherwise usual transfer of information on the workpiece itself are therefore not possible.

### SUBJECT MATTER OF THE INVENTION

An object of the invention is to provide a workpiece which is provided with a coding or marking under the aforementioned framework conditions and which receives and/or can receive information, in particular workpiece-specific information.

The subject matter of claim 1 provides a corresponding workpiece. Other preferred embodiments are specified in the dependent claims. The invention further relates to a method.

Provided is a workpiece with a manufactured surface structure that forms a decorative pattern, wherein an optically detectable coding is integrated in a reference area in the surface structure of the workpiece.

The invention has the advantage that a coding or marking of workpieces is integrated in the visible surface of the workpiece without the marking being recognizable as such to a viewer. The marking therefore does not affect the aesthetic impression. Rather, the marking is integrated in the visually perceptible surface of the workpiece and is thus part of the decorative pattern of the workpiece. The marking can be detected by an optical sensor, and its information content can be decoded by a control device.

Since the marking (coding) is integrated in the workpiece surface, the marking can be generated when manufacturing the surface structure. This ensures consistent marking of the workpiece already during manufacture and thus increases product safety. Furthermore, the marking remains attached to the workpiece over its lifetime, whereas there is the risk with known barcode stickers or printed labels that these will peel off or be rubbed off.

The marking can be used, for example, to link workpiece-specific information such as material data, date of manufacture, workpiece number or the like with the workpiece.

“Manufactured surface structure” means a surface structure formed by machining, treatment or buildup. In particular, a layer forming the surface structure can be provided on a surface of a base workpiece, or the workpiece is manufactured together with the surface structure by an additive process. Furthermore, the surface structure can be manufactured by a subtractive process. The above-mentioned processes can also be individually combined.

A decorative pattern is the exterior of the surface structure that is visually perceived by the viewer. For example, it can be a wooden decorative pattern that imitates a wood surface.

According to one embodiment, it is provided that the coding comprises information parameters, wherein the position in the reference area and/or a relation of the area of the information parameters to the area of the reference area constitute or comprise information. In this way, the coding can be provided unobtrusively on the workpiece.

The reference area can be formed by several points provided in the surface structure. If the surface structure is a wood look, the dots can, for example, be formed as knotholes or the like. The reference area can accordingly be defined on the basis of visually perceptible features.

The coding may include information parameters formed as a corrugated structure. This embodiment has proven to be particularly advantageous for integrating a coding in the visible surface of the workpiece.

The workpiece may further be configured such that the coding is integrally formed with the workpiece. Thus, the coding is firmly linked to the workpiece and is thus part of the decorative pattern of the workpiece.

The workpiece can be formed in layers, in particular by an additive process. This allows the manufacturing of a large number of variants. It is thereby preferred that the coding is also created when manufacturing the workpiece.

In a further embodiment, it is provided that the workpiece is a piece of furniture or a part of a piece of furniture.

It is preferred that the coding is configured to be optically detectable, in particular by means of a 3D scanning method. Thus, the coding can be read out, for example, by a corresponding device and the read-out information can be directly used further.

It is furthermore preferred that the surface structure comprises a wood structure, a motif or an image. When a wood structure is used, for example, knotholes or the like can define a reference area. If there is a motif or an image, the reference area can be defined by features of the motif or the image.

The invention further relates to a method for manufacturing a workpiece, wherein a coding is formed on the workpiece in the surface structure when creating the surface structure.

The method has, inter alia, the advantage that a marking of workpieces can be integrated in the visible surface of the workpiece without the marking being recognizable as such to a viewer. Consequently, the marking does not affect the aesthetic impression; rather, the marking is integrated in the visually perceptible surface of the workpiece and is thus part of the decorative pattern of the workpiece. For example, it is possible to detect the marking by means of an optical sensor and to decode its information content with a control device.

In one embodiment of the method, it is provided that the coding is formed by an irregularly shaped surface structure. As a further embodiment, the coding may be formed as a corrugated structure.

The method can further be realized in such a manner that the workpiece is formed in layers, in particular by means of an additive process, in particular by means of a fusion layer process.

It is preferred that the coding and/or the reference area is formed by a printing process, in particular by inkjet printing, or an additive process. Thus, the coding can be formed individually for a specific workpiece.

In one embodiment of the method, it is provided that the coding is configured to be optically detectable, in particular by means of a 3D scanning method.

The features of the method can each be used individually to further specify the previously described workpiece. Features of the previously described workpiece can also be formed during the manufacture of the workpiece.

### BRIEF DESCRIPTION OF THE FIGURES

FIG. 1 shows a plan view of a workpiece according to a first embodiment of the invention.

FIG. 2 shows a plan view of a workpiece according to a second embodiment of the invention.

### DESCRIPTION OF THE PREFERRED EMBODIMENTS

Preferred embodiments of the invention will be explained by means of the enclosed figures. Although the embodiments are to be understood purely as examples, and are not restrictive, features of the embodiments described below can also be used individually or in combination with other features to specify the invention. Moreover, the described embodiments can also be combined with each other to form further embodiments of the invention.

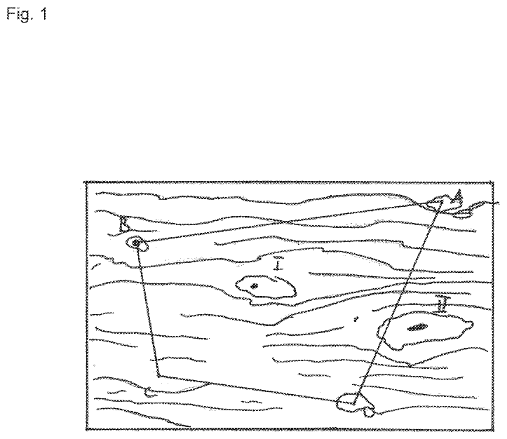

FIG. 1 shows a plan view of a plate-shaped workpiece provided with a surface structure. In the present example, the surface structure is intended to imitate a wood surface. In other embodiments, images, motifs or the like can also be provided as a surface structure.

The surface structure can be applied to the surface of a workpiece using a 3D printing method, or by means of an inkjet or laser printer. It is also possible to provide the surface structure in the surface of the workpiece when additively forming the workpiece.

The surface structure of the workpiece is used to imitate a wood surface which can be found in such a surface through cut annual rings, knotholes or other regularly or irregularly formed features.

In the surface of the workpiece, a reference area is defined between characteristic points A, B, C, D. In the present case, the characteristic points are formed by knotholes, wherein the type of the characteristic points is defined depending on the specifically selected surface structure. In the present embodiment example, points A-D are each central points in the area of the respective knothole.

To illustrate the reference area, the characteristic points A-D in FIG. 1 are connected by lines in such a manner as to depict a polygonal, two-dimensional area. The area defined by corner points A-D is also called the search field.

The workpiece shown in FIG. 1 further comprises information parameters I, II formed as knotholes on the surface of the workpiece. The information parameters I, II are characterized by an irregularly formed area. As in the case of the characteristic points, the configuration of information parameters I, II is defined depending on the specifically selected surface structure.

By means of an optical sensor, the surface of the workpiece can be detected, and the search field defined between the corner points A, B, C, D can be identified. Furthermore, the borders, and thus the area, of the information parameters I, II are detected. The arrangement of the information parameters I, II in the search field and the overlapping of the information parameters I, II with the border of the search field define individual information that is used to mark the workpiece.

According to one embodiment, the sensors are in communication with a database stored in a cloud, and therefore specific information can be retrieved based on the detection of the marking of a workpiece.

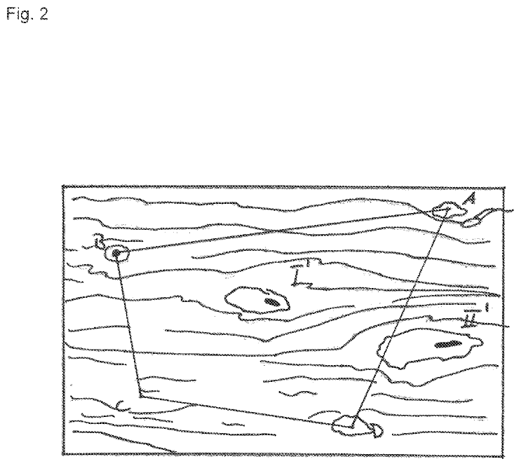

FIG. 2 shows a second example of a workpiece with a surface formed similar to that shown in FIG. 1. However, in the embodiment shown in FIG. 2, two information parameters I′, II′ are formed, the extent and dimension of which differ from those shown in FIG. 1. Owing to the arrangement as well as overlapping of the information parameters I′, II′ in or with the search field defined by the corner points A, B, C, D, information different from the embodiment shown in FIG. 1 is stored, which accordingly specifies and identifies the workpiece shown in FIG. 2.

Since the characteristic points A, B, C, D and the information parameters in the embodiment examples are formed as knotholes, they are not perceived by the viewer of the workpiece as a marking in the sense of a barcode or QR code. Rather, the viewer sees the characteristic dots and the information parameters as part of the actual decorative pattern. Deviations between individual workpieces may be recognized by the viewer as variations in the decorative pattern when workpieces are arranged next to each other, for example in ceiling or floor panels. This fact thus contributes to increasing the perceived value of the workpiece.

1. Workpiece with a manufactured surface structure that forms a decorative pattern,
wherein an optically detectable code is integrated in a reference area in the surface structure of the workpiece.

2. Workpiece according to claim 1, wherein the coding comprises information parameters, wherein the position in the reference area and/or a relation of the area of the information parameters to the area of the reference area represent or contain information.

3. Workpiece according to claim 1, wherein the reference area is formed by a plurality of dots provided in the surface structure.

4. Workpiece according to claim 1, wherein the coding comprises information parameters formed as a corrugated structure.

5. Workpiece according to claim 1, wherein the coding is formed integrally with the workpiece.

6. Workpiece according to claim 1, wherein the workpiece is formed in layers.

7. Workpiece according to claim 1, wherein the workpiece is a furniture piece or a part of a furniture piece.

8. Workpiece according to claim 1, wherein the coding is configured to be optically detectable.

9. Workpiece according to claim 1, wherein the surface structure comprises a wood structure, a motif or an image.

10. Method for manufacturing a workpiece,
wherein a coding is formed on the workpiece in the surface structure when creating the surface structure.

11. Method according to claim 10, wherein the coding is formed by an irregularly formed surface structure.

12. Method according to claim 10, wherein the coding is formed as a corrugated structure.

13. Method according to claim 10, wherein the workpiece is formed in layers.

14. Method according to claim 10, wherein the coding and/or the reference area is formed by inkjet printing, or by an additive process.

15. Method according to claim 10, wherein the coding is configured to be optically detectable.

16. Workpiece according to claim 6, wherein the workpiece is formed by an additive process.

17. Workpiece according to claim 8, wherein the coding is configured to be optically detectable by a 3D scanning method.

18. Method according to claim 14, wherein the workpiece is formed in layers by an additive process.

19. Method according to claim 18, wherein the additive process is a melt layer process.

20. Method according to claim 15, wherein the coding is configured to be optically detectable by a 3D scanning method.
